(19) United States
(12) Patent Application Publication
(10) Pub. No.: US 2010/0183166 A1
(43) Pub. Date: Jul. 22, 2010

(54) EXTERNAL CAR AMPLIFIER CAPABLE OF PRODUCING HIGH POWER

(76) Inventor: Simon Shan Lin Sun, La Puente, CA (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/356,311

(22) Filed: Jan. 20, 2009

(51) Int. Cl. H04B 1/00

(52) U.S. Cl. 381/86

(57) ABSTRACT

An external car amplifier includes an audio amplifier module; a pulse width modulation (PWM) module electrically connected to the audio amplifier module to receive signals generated by a phase inverting unit and a source amplifying unit of the audio amplifier module and compare the same with a signal in the PWM module to generate a PWM signal; a drive amplifier module coupled to the PWM module and controlled by the PWM signal to on/off and generating a high-current audio signal; an on/off control and mute module for receiving a control signal to control the drive amplifier module; and a filter and power supply module electrically connected to the audio amplifier module, the PWM module, the drive amplifier module, and the on/off control and mute module. With these arrangements, the external car amplifier can have reduced production cost and power consumption and output a high-current and high-power signal at high efficiency.

### FIELD OF THE INVENTION

The present invention relates to an external car amplifier capable of producing high power, and more particularly, to an external car amplifier capable of outputting a high-current, high-power audio signal.

### BACKGROUND OF THE INVENTION

Following the highly upgraded living quality, people also demand for higher sound effect when they enjoy listening music, even during driving. Most of the currently commercially available in-car stereos fail to satisfy car owners in terms of stereo effect and sound blast effect. When it is desired to imp-rove the sound blast effect of an in-car stereo, an external car amplifier must be additional mounted on the car to meet the car owner's requirement. Therefore, many users will request the car manufacture to add a car amplifier to the car when buying a new car. That is, an external car amplifier has become a prerequisite device for a car owner to enjoy a thudding sound blast effect in the car.

Most of the conventional car amplifiers are analog power amplifiers, which are generally class AB amplifiers. The class AB amplifiers provide good total harmonic distortion performance and are linear audio amplifiers. Conventionally, the linear audio amplifier uses transistors to form a linear driver at an, output thereof for limiting the voltage amplitude of an output load, so that the amplifier can work within a linear region. As a result, a large amount of power is consumed at the output-stage transistors, making the class AB amplifier poor in general efficiency thereof.

Further, in designing a conventional 20 W or higher car power amplifier, an additional boost circuit is needed to boost and convert a 12V car power supply into a required high voltage value, such as a voltage value as high as 48V or more, for use as a power supply to the amplifying circuit, such as the aforesaid class AB amplifier. In this case, the amplifying circuit must be connected to a dual power supply, and there will have about 10% to 20% energy loss in the process of energy conversion by the boost circuit. Moreover, the class AB amplifier under a high voltage and high current will also have high amount of energy loss. Therefore, the class AB amplifier can usually have an amplifier efficiency of about 40% to 60%. For example, a 500W class AB amplifier can have a highest amplifier efficiency of 60% only.

Therefore, the conventional car amplifier is subject to loss in energy conversion and will cause a large amount of energy loss. Meanwhile, in using the conventional car amplifier, more power is consumed when the produced sound is louder, which will result in the production of high amount of heat. The produced heat must be dissipated using radiating fins, which will inevitably increase the production cost of the car amplifier. Therefore, the conventional can amplifier requires higher production cost and consumers more power.

In brief, the conventional car amplifier has the following disadvantages: (1) requiring increased production cost; (2) consuming more power; and (3) having low amplifier efficiency.

It is therefore tried by the inventor to develop an improved external car amplifier capable of producing high power to overcome the drawbacks in the conventional car amplifiers.

### SUMMARY OF THE INVENTION

A primary object of the present invention is to provide an external car amplifier capable of outputting a high-current and high-power audio signal at high efficiency.

Another object of the present invention is to provide an external car amplifier that is capable of producing high power and can be manufactured at reduced cost.

A further object of the present invention is to provide an external car amplifier that is capable of producing high power at reduced power consumption.

A still further object of the present invention is to provide an external car amplifier capable of producing high power, which directly uses a car battery as a power supply thereof without the need of a boost circuit.

To achieve the above and other objects, the external car amplifier capable of producing high power according to a preferred embodiment of the present invention includes an audio amplifier module having a source amplifying unit for receiving an input audio signal and a phase inverting unit coupled to the source amplifying unit for inverting the signal phase of the received input audio signal; a pulse width modulation (PWM) module electrically connected to the audio amplifier module for receiving signals generated by the phase inverting unit and the source amplifying unit and comparing the same with a signal in the PWM module to generate a PWM signal; a drive amplifier module coupled to the PWM module and having an output-stage unit and a power amplifying unit, the PWM signal controlling the output-stage unit and being amplified and filtered by the power amplifying unit to generate a high-current audio signal; an on/off control and mute module for receiving a control signal to control the drive amplifier module; and a filter and power supply module having a power filtering unit and a power supplying unit, the power filtering unit being electrically connected to the power amplifying unit, the on/off control and mute module, and the power supplying unit, and the power supplying unit being electrically connected to the audio amplifier module, the PWM module, and the drive amplifier module. With the above arrangements, the external car amplifier of the present invention can have effectively reduced production cost and power consumption, and can output a high-current and high-power signal at high efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an external car amplifier according to a preferred embodiment of the present invention;

FIG. 2 is another block diagram of the external car amplifier of the present invention showing more structural details thereof;

FIG. 3 is a circuit diagram of the external car amplifier of the present invention; and

FIG. 4 is another circuit diagram of the external car amplifier of the present invention.

### DETAILED DESCRIPTION OF THE PREFERRED EMBODIMENTS

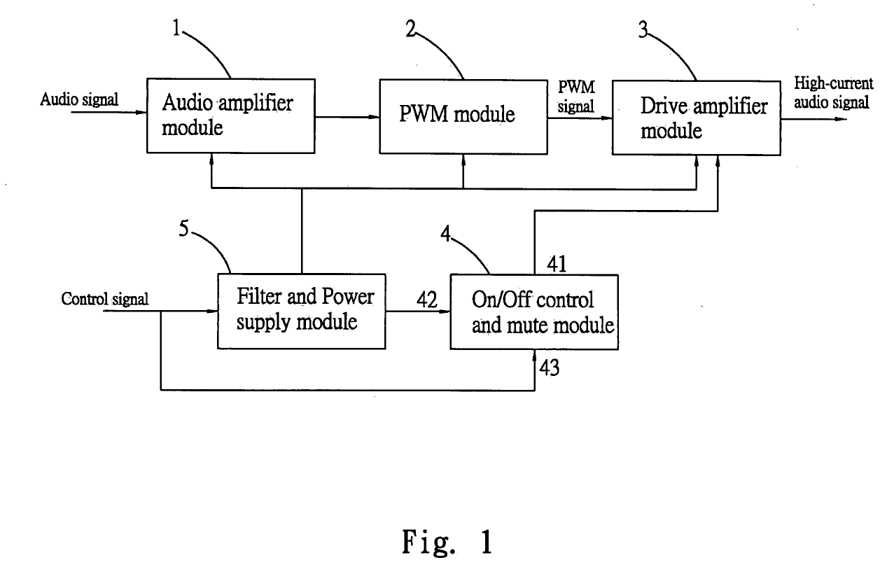

Please refer to FIG. 1 that is a block diagram of an external car amplifier capable of producing high power according to a preferred embodiment of the present invention. As shown, the external car amplifier in the preferred embodiment includes an audio amplifier module 1, a pulse width modulation (PWM) module 2, a drive amplifier module 3, anon/off control and mute module 4, and a filter and power supply module 5.

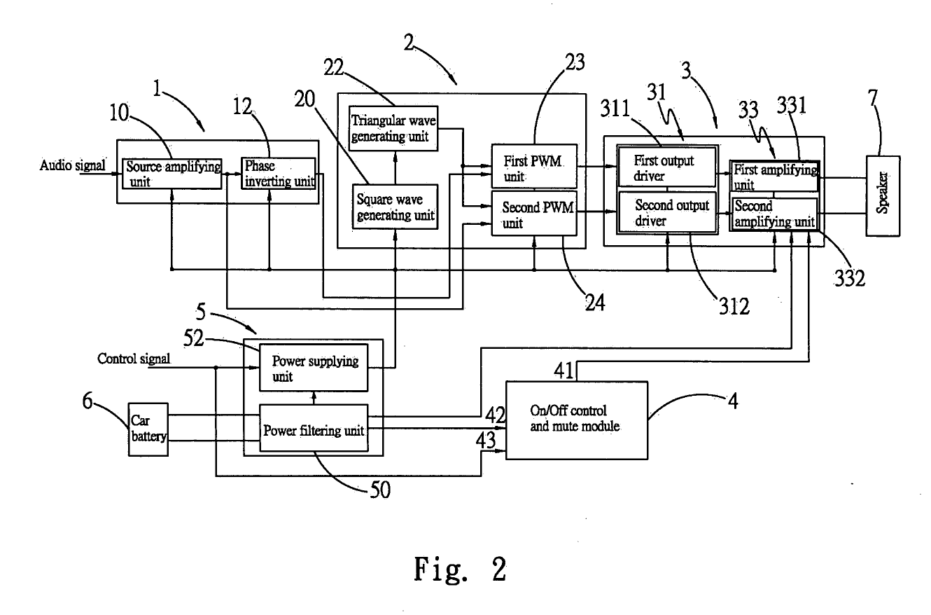

Please refer to FIG. 2 that is another block diagram of the external car amplifier of the present invention showing more structural details thereof. As shown, the audio amplifier module 1 includes a source amplifying unit 10 for receiving an input audio signal, and a phase inverting unit 12 for inverting the signal phase of the received audio signal. The source amplifying unit 10 is coupled to the phase inverting unit 12. The input audio signal is the sound signal transmitted by an in-car electronic product.

The PWM module 2 is electrically connected to the audio amplifier module 1 for receiving and comparing signals transmitted from the phase inverting unit 12 and the source amplifying unit 10 with a signal in the PWM module 2, so as to generate a PWM signal.

The drive amplifier module 3 has an output-stage unit 31 and a power amplifying unit 33. The PWM signal generated by the PWM module 2 controls the on/off of the output-stage unit 31, and is amplified and filtered by the power amplifying unit 33 to generate a high-current audio signal.

The on/off control and mute module 4 receives a control signal for controlling the drive amplifier module 3. In other words, the on/off control and mute module 4 follows the received control signal to control the power on/off of the output-stage unit 31 and the power amplifying unit 33 of the drive amplifier module 3, and to shut off the output of the aforesaid high-current audio signal to provide a mute function.

The filter and power supply module 5 includes a power filtering unit 50 and a power supplying unit 52. The power filtering unit 50 is electrically connected to the power amplifying unit 33, the on/off control and mute module 4, and the power supplying unit 52. The power supplying unit 52 is coupled to the audio amplifier module 1, the PWM module 2, and the drive amplifier module 3.

The power filtering unit 50 is coupled to a car battery 6 for filtering the power supply from the car battery 6 and supplying the filtered power supply to the power supplying unit 52, the on/off control and mute module 4, and the power amplifying unit 33. The power supplying unit 52 supplies power to the audio amplifier module 1, the PWM module 2, the drive amplifier module 3, and the on/off control and mute module 4.

As can be seen from FIG. 2, the PWM module 2 includes a square wave generating unit 20, a triangular wave generating unit 22, a first PWM unit 23, and a second PWM unit 24. The square wave generating unit 20 is electrically connected to the power supplying unit 52 for generating a square wave signal. The triangular wave generating unit 22 is coupled to the square wave generating unit 2Q, and is used to receive and convert the square wave signal into a triangular wave signal.

The first PWM unit 23 is coupled to the triangular wave generating unit 22 and the phase inverting unit 12, and conduct comparisons on the triangular wave signal and a phase-inverted audio signal generated by the triangular wave generating unit 22 and the phase inverting unit 12, respectively, to generate a first PWM signal. The second PWM unit 24 is electrically connected to the source amplifying unit 10 and the triangular wave generating unit 22, and conducts comparisons on an amplified input audio signal and the triangular wave signal generated by the source amplifying unit 10 and the triangular wave generating unit 22, respectively, to generate a second PWM signal. The aforesaid PWM signal consists of the first PWM signal and the second PWM signal.

The output-stage unit 31 includes a first output driver 311 and a second output driver 312, which are connected to the first PWM unit 23 and the second PWM unit 24, respectively, and to the power supplying unit 52. The first and the second PWM signal generated by the first and the second PWM unit 23, 24, respectively, control the on/off of the first and the second output drivers 311, 312, respectively. For example, when the first PWM signal controls the first output driver 311 to on or off, the second PWM signal will correspondingly controls the second output driver 312 to off or on. When the first and the second PWM signal have respectively controlled the first and the second output driver 311, 312 to switch between high level and low level, the first and second PWM signals are amplified and filtered by the power amplifying unit 33 to generate the aforesaid high-current audio signal. It is noted the first and the second output driver work alternately to switch between on and off state at a very quick speed to thereby have very high efficiency while produce relatively low heat.

The power amplifying unit 33 includes a first amplifying device 331 and a second amplifying device 332, which are coupled to the first and the second output driver 311, 312, respectively, and to the power supplying unit 52, the on/off control and mute module 4, and the power filtering unit 50. In addition, the power amplifying unit 33 is electrically connected to a speaker 7. In other words, the first amplifying device 331 and the second amplifying device 332 of the power amplifying unit 33 are coupled to a positive and a negative terminal of the speaker 7, respectively. The first and the second PWM signal are respectively amplified by the first and the second amplifying device 331, 332 and filtered by a low-pass filter circuit in each of the two amplifying devices 331, 332 to generate the aforesaid high-current audio signal for driving the speaker 7. In the illustrated preferred embodiment, the speaker 7 is a horn used to output the high-current audio signal.

Please refer to FIG. 2. The on/off control and mute module 4 includes a first terminal 41, a second terminal 42, and a third terminal 43. The first terminal 41 is electrically connected to the power amplifying unit 33, the second terminal 42 is coupled to the power filtering unit 50 for receiving electric power supplied by the car battery 6 and filtered by the power filtering unit 50, and the third terminal 43 is used to receive the above-mentioned input control signal.

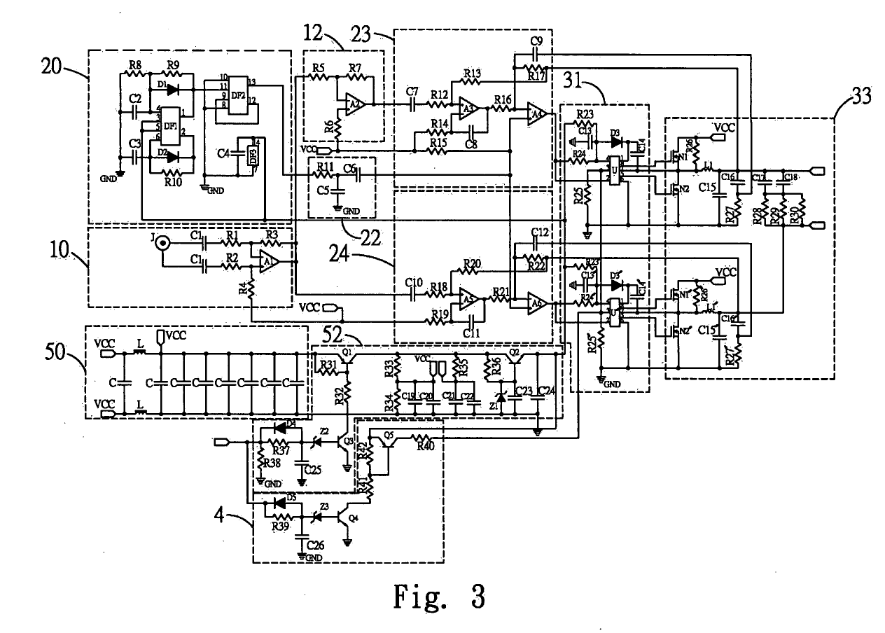

The structure of the present invention will now be described in more details with reference to FIGS. 2 and 3.

The source amplifying unit 10 of the audio amplifier module 1 consists of two first capacitors C1, a, first resistor R1, a second resistor R2, a third resistor R3, a fourth resistor R4, an audio source connector J, and a first operational amplifier A1. The first capacitors elements C1 each have a first end electrically connected to the audio source connector J, and a second end coupled to a first end of the first resistor R1 and the second resistor R2, respectively. The first operational amplifier A1 has a positive input coupled to a second end of the second resistor R2 and a first end of the fourth resistor R4, a negative input electrically connected to a second end of the first resistor R1 and a first end of the third resistor R3, and an output electrically connected to a second end of the third resistor R3. The output of the first operational amplifier A1 is used to output the aforesaid amplified input audio signal. The fourth resistor R4 has a second end coupled to a voltage source VCC. The audio source connector J is provided for a plug of an electronic product (not shown) to plug therein.

The phase inverting unit 12 consists of a fifth resistor R5, a sixth resistor R6, a seventh resistor R7, and a second operational amplifier A2. The second operation amplifier A2 has a negative input electrically connected to a first end of the fifth resistor R5 and a first end of the seventh resistor R7, a positive input coupled to a first end of the sixth resistor R6, and an output coupled to a second end of the seventh resist or R7. A second end of the fifth resistor R5 and of the sixth resistor R6 are coupled to an output of the first operational amplifier A1 and the voltage source VCC, respectively. The output of the second operational amplifier A2 is used to output the previously mentioned phase-inverted audio signal.

The square wave generating unit 20 consists of an eighth resistor R8, a ninth resistor R9, a tenth resistor R10, a second capacitor C2, a third capacitor C3, a fourth capacitor C4, a first diode D1, a second diode D2, a first D-type flip-flop DF1, a second D-type flip-flop DF2, and a third D-type flip-flop DF3. The first, the second, and the third D-type flip-flop DF1, DF2, DF3 have total fourteen pins. The first D-type flip-flop DF1 has a first pin coupled to a first end of the ninth resistor R9 and a first end of the first diode D1, and a second pin electrically connected to a first end of the second diode D2 and a first end of tenth resistor R10.

The first D-type flip-flop DF1 has a third pin electrically connected to a fifth pin thereof, a fourth pin coupled to a first end of the second capacitor C2 and of the eighth resistor R8 as well as a second end of the ninth resistor R9 and of the first diode D1, and a sixth pin coupled to a first end of the third capacitor C3 and a second end of the second diode D2 and of the tenth resistor R10. And, the eighth resistor R8, the second capacitor C2, and the third capacitor C3 are connected at respective second end to a ground GND.

The second D-type flip-flop DF2 has an eighth pin and a tenth pin electrically connected to the ground GND, a ninth pin coupled to a twelfth pin, an eleventh pin coupled to a junction of the first end of the ninth resistor R9 and the first end of the first diode D1, and a thirteenth pin coupled to the triangular wave generating unit 22 for outputting the square wave signal. The third D-type flip-flop DF3, has a fourteenth pin coupled to a first end of the fourth capacitor C4 and the fifth pin of the first D-type flip-flop DF1, and a seventh pin electrically connected to a second end of the fourth capacitor C4 and the ground GND.

As can be seen from FIG. 3, the triangular wave generating unit 22 consists of an eleventh resistor R11, a fifth capacitor C5, and a sixth capacitor C6. The eleventh resistor R11 has a first end coupled to the thirteenth pin of the second D-type flip-flop DF2, and a second end electrically connected to a first end of the fifth capacitor C5 and of the sixth capacitor C6. The fifth capacitor C5 is coupled at a second end to the ground GND, and the sixth capacitor C6 is connected at a second end to the first and the second PWM unit 23, 24 for outputting the aforesaid triangular wave signal.

The first PWM unit 23 consists of a twelfth resistor R12, a thirteenth resistor R13, a fourteenth resistor R14, a fifteenth resistor R15, a sixteenth resistor R16, a seventeenth resistor R17, a seventh capacitor C7, an eighth capacitor C8, a ninth capacitor C9, a third operational amplifier A3, and a fourth operational amplifier A4. The third operational amplifier A3 has a positive input coupled to a first end of the twelfth resistor R12 and of the thirteenth resistor R13, a negative input coupled to a first end of the fourteenth resistor R14 and of the eighth capacitor C8, and an output electrically connected to a junction of a first end of the sixteenth resistor R16 and a second end of the eighth capacitor C8.

The fourteenth resistor R14 has a second end coupled to a second end of the fifteenth resistor R15, and the second ends of the fourteenth and fifteenth resistors R14, R15 are together coupled to the voltage source VCC. The twelfth resistor R12 has a second end electrically connected to a first end of the seventh capacitor C7, and a second end of the seventh capacitor C7 is coupled to an output of the second operational amplifier A2. The seventeenth resistor R17 has a first end connected to a second end of the thirteenth resistor R13, and a second end electrically connected to a first end of the ninth capacitor C9.

The fourth operational amplifier A4 has a negative input coupled to a second end of the sixteenth resistor R16 and further electrically connected to a junction of the second end of the seventeenth resistor R17 and the first end of the ninth capacitor C9, a positive input connected to a first end of the fifteenth resistor R15 and the second end of the sixth capacitor C6, and an output electrically connected to the first output driver 311 for outputting the previously mentioned first PWM signal.

The second PWM unit 24 consists of an eighteenth resistor R18, a nineteenth resistor R19, a twentieth resistor R20, a twenty-first resistor R21, a twenty-second resistor R22, a tenth capacitor C10, a eleventh capacitor C11, a twelfth capacitor C12, a fifth operational amplifier A5, and a sixth operational amplifier A6. The fifth operational amplifier A5 has a positive input coupled to a first end of the eighteenth resistor R18 and of the twentieth resistor R20, a negative input coupled to a first end of the nineteenth resistor R19 and of the eleventh capacitor C11, and an output electrically connected to a junction of a first end of the twenty-first resistor R21 and a second end of the eleventh capacitor C11.

The eighteenth resistor R18 has a second electrically connected to a first end of the tenth capacitor C10, and a second end of the tenth capacitor C10 is coupled to the output of the first operational amplifier A1. The twenty-second resistor R22 has a first end connected to a second end of the twentieth resistor R20, and a second end electrically connected to a first end of the twelfth capacitor C12. The nineteenth resistor R19 has a second end coupled to the voltage source VCC.

The sixth operational amplifier A6 has a negative input coupled to a second end of the twenty-first resistor R21 and then further electrically connected to a junction of the second end of the twenty-second resistor R22 and the first end of the twelfth capacitor C12, a positive input electrically connected to the positive input of the fourth operational amplifier A4, and an output connected to the second output driver 312 for outputting the previously mentioned second PWM signal.

Please further refer to FIGS. 2 and 3 at the same time. The first output driver 311 consists of a twenty-third resistor R23, a twenty-fourth resistor R24, a thirteenth capacitor C13, a fourteenth capacitor C14, a third diode D3, and a metal-oxide-semiconductor field-effect (MOSFET) transistor U. The MOSFET transistor U has eight pins, of which the first pin is coupled to a cathode of the third diode D3 and a first end of the fourteenth capacitor C14, the seventh pin is connected to a second end of the fourteenth capacitor C14, and the second pin is electrically connected to a first end of the twenty-fourth resistor R24 and the output of the fourth operational amplifier A4.

The twenty-fifth resistor R25 has a first end coupled to the third pin of the MOSFET transistor U, and a second connected to the ground GND and the sixth pin of the MOSFET transistor U. The fourth pin of the MOSFET transistor U is coupled to a second end of the twenty-fourth resistor R24, a first end of the thirteenth capacitor C13, and a first end of the twenty-third resistor R23. The thirteenth capacitor C13 has a second end connected to the ground GND, and the twenty-third resistor R23 has a second end electrically connected to the fourteenth pin of the third D-type flip-flop DF3. The eighth and the fifth pin of the MOSFET transistor U are connected to the first amplifying device 331.

The second output driver 312 is generally the same as the first output driver 311 in terms of its overall structure and connections among different components, therefore, only the portions thereof that are different from the first output driver 311 will be discussed herein. The second output driver 312 is different from the first output driver 311 in having a MOSFET transistor U′. A third pin of the MOSFET transistor U′ is coupled to the third pin of the MOSFET transistor U of the first output driver 311 and the on/off control and mute module 4. The second output driver 312 also has a twenty-third resistor R23′, which has a first end electrically connected to a fourth pin of the MOSFET transistor U′, a second end of a twenty-fourth resistor R24′, and a first end of a thirteenth capacitor C13′. A second end of the twenty-third resistor R23′ is coupled to the second end of the twenty-third resistor R23 of the first output driver 311.

Also, a second pin of the MOSFET transistor U′ of the second output driver 312 is coupled to the output of the sixth operational amplifier A6 and a first end of the twenty-fourth resistor R24′ of the second output driver 312, and an eighth and a fifth pin of the MOSFET transistor U′ are connected to the second amplifying device 332.

Please further refer to FIG. 3. The first amplifying device 331 consists of a first n-channel MOSFET (NMOS) transistor N1, a second NMOS transistor N2, a twenty-sixth resistor R26, a twenty-seventh resistor R27, a first inductor L1, a fifteenth capacitor C15, and a sixteenth capacitor C16. The first NMOS transistor N1 has a gate electrically connected to an eighth pin of the MOSFET transistor U of the first output driver 311, the second NMOS transistor N2 has a gate electrically connected to a fifth pin of the MOSFET transistor U of the first output driver 311. The first NMOS transistor N1 has a source coupled to a drain of the second NMOS transistor N2, a seventh pin of the MOSFET transistor U of the first output driver 311, and a first end of the twenty-sixth resistor R26 and of the first inductor L1. The previously mentioned first PWM signal is input to the first and the second NMOS transistor N1, N2 for amplifying to generate a first high-current PWM signal at a junction of the first end of the twenty-sixth resistor R26 and the first end of the first inductor L1.

The first NMOS transistor N1 has a drain coupled to a second end of the twenty-sixth resistor R26 and the voltage source VCC. The second NMOS transistor N2 has a source coupled to the ground GND. The first inductor L1 has a second end electrically connected to a first end of each of the fifteenth to the eighteenth capacitor C15-C18, the first end of the seventeenth resistor R17, and the positive terminal of the speaker 7. A second end of the fifteenth capacitor C15 and a first end of the twenty-seventh resistor R27 are coupled to the ground GND. A second end of the sixteenth capacitor C16, a second end of the twenty-seventh resistor R27, and a second end of the ninth capacitor C9 are electrically connected to one another. Wherein, the second end of the first inductor L1 and the fifteenth capacitor C15 forms the previously mentioned low-pass filter circuit for filtering out undesired high-frequency signal. The aforesaid first high-current PWM signal flows through the low-pass filter circuit and is filtered by the latter to generate the previously mentioned high-current audio signal at a junction of the second end of the first inductor L1 and the first end of the fifteenth capacitor C15.

The first amplifying device 331 further consists of twenty-eighth to thirtieth resistors R28-R30. The twenty-eighth to thirtieth resistors R28-R30 are electrically connected at respective first end to a second end of the seventeenth and of the eighteenth capacitor C17, C18, and at respective second end to the negative terminal of the speaker 7, so that the aforesaid high-current audio signal is output from the first end of the eighteenth capacitor C18 and the second end of the thirtieth resistor R30 to drive the speaker 7.

The second amplifying device 332 is generally the same as the first amplifying device 331 in terms of its overall structure and connections among different components, therefore, only the portions thereof that are different from the first amplifying device 331 will be discussed herein. The second amplifying device 332 is different from the first amplifying device 331 in a first NMOS transistor N1′ electrically connected at a gate to an eighth pin of the MOSFET transistor U′ of the second output driver 312, a second NMOS transistor N2′ electrically connected at a gate to a fifth pin of the MOSFET transistor U′ of the second output driver 312, and a sixteenth capacitor C16′ that has a first end coupled to a second end of a first inductor L1′ and of a twenty-eighth resistor R28′ and a second end electrically connected to a first end of a twenty-seventh resistor R27′ and a second end of the twelfth capacitor C12. A second end of the twenty-seventh resistor R27′ is coupled to the ground GND.

And, the second amplifying device 332 has a twenty-sixth resistor R26′ coupled at a first end to a first end of the first inductor L1′. The previously mentioned second PWM signal is input to the first and the second NMOS N1′, N2′ and is amplified thereat to generate a second high-current PWM signal at a junction of the first end of the twenty-sixth resistor R26′ and the first end of the first inductor L1′. And, the second high-current PWM signal flows through the aforesaid low-pass filter circuit and is filtered thereat to generate the previously mentioned high-current audio signal at a junction of the second end of the first inductor L1′ and a first end of a fifth capacitor C15′.

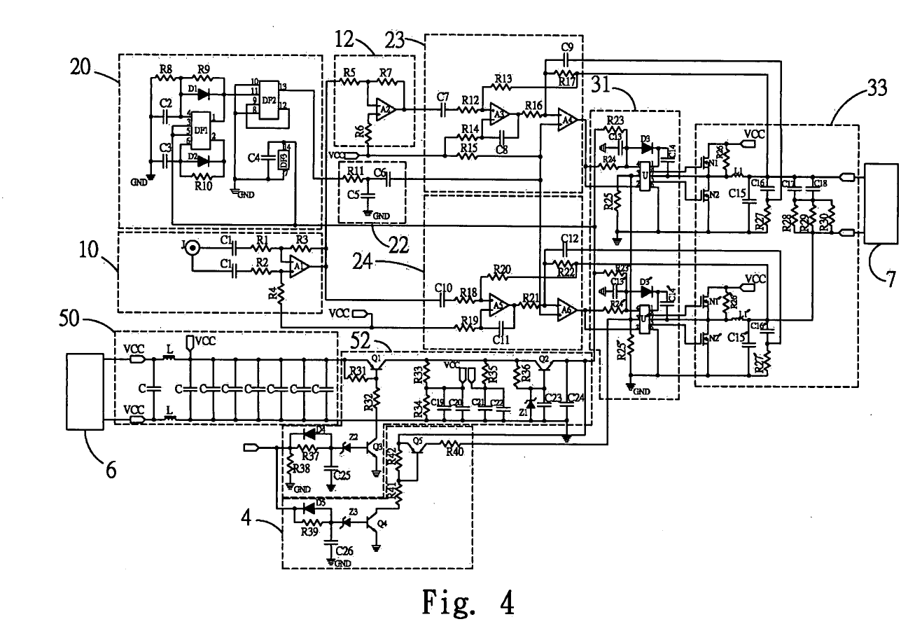

Please now refer to FIGS. 3 and 4 at the same time. The power filtering unit 50 consists of eight capacitors. C and two inductors L. A first one of the two inductors L is coupled to and between first ends of the first and the second capacitor C, and the second inductor L is coupled to and between second ends of the first and the second capacitor C. The first capacitor C is further electrically connected at the first and second ends to the aforesaid car battery 6, and the second capacitor C is sequentially connected to the remaining six capacitors C in parallel. Further, the second to the eighth capacitor C are electrically connected at their respective positive terminal to the voltage source VCC and the power supplying unit 52, and coupled at their respective negative terminal to the ground GND directly.

The power supplying unit 52 consists of thirty-first to thirty-eighth resistors R31-R38, nineteenth to twenty-fifth capacitors C19-C25, a first Zener diode Z1, a second Zener diode Z2, a fourth diode D4, a first bipolar junction transistor (BJT transistor) Q1, a second BJT transistor Q2, and a third BJT transistor Q3. The first BJT transistor Q1 has a base coupled to a first end of the thirty-first resistor R31 and of the thirty-second resistor R32, and an emitter coupled to a second end of the thirty-first resistor R1 and the positive terminal of the eighth capacitor C of the power filtering unit 50.

Further, the third BJT transistor Q3 has a collector electrically connected to a second end of the thirty-second resistor R32, an emitter directly coupled to the ground GND, and a base coupled to a positive terminal of the second Zener diode Z2. The second Zener diode Z2 has a negative terminal electrically connected to a first end of the thirty-seventh resistor R37, of the twenty-fifth capacitor C25, and of the fourth diode D4. Second ends of the fourth diode D4 and the thirty-seventh resistor R37 are coupled to a first end of the thirty-eighth resistor R38 for inputting the control signal. In brief, the control signal is input at the junction of the second end of the fourth diode D4, the second end of the thirty-seventh resistor R37, and the first end of thirty-eighth resistor R38.

The second BJT transistor Q2 has a collector electrically connected to first ends of the thirty-third, thirty-fifth, and thirty-sixth resistors R33, R35, R36′ and a collector of the first BJT transistor Q1. A second end of the thirty-third resistor R33 is coupled to first ends of the thirty-fourth resistor R34, the nineteenth capacitor C19, and the twentieth capacitor C20 and to the voltage source VCC. A second end of the thirty-fifth resistor R35 is electrically connected to first ends of the twenty-first capacitor C21 and the twenty-second capacitor C22 and to the voltage source VCC. And, a second end of the thirty-fourth resistor R34 is coupled to second ends of the nineteenth to the twenty-second capacitor C19-C22 and to the ground GND.

The second BJT transistor Q2 has a base electrically connected to a second end of the thirty-sixth resistor R36 and first ends of the first Zener diode Z1 and the twenty-third capacitor C23, and an emitter coupled to a first end of the twenty-fourth capacitor C24 and second ends of the twenty-third resistors R23, 23′ of the first and second output drivers 311, 312, respectively. And second ends of the twenty-third and twenty-fourth capacitors C23, C24 and the first Zener diode Z1 are connected to the ground GND.

Also as shown in FIGS. 3 and 4, the on/off control and mute module 4 consists of thirty-ninth to forty-second resistors R39-R42, a twenty-sixth capacitor C26, a fifth diode D5, a third Zener diode Z3, a fourth BJT transistor Q4, and a fifth BJT transistor Q5. The fourth BJT transistor Q4 has a base coupled to a first end of the third Zener diode Z3. An emitter of the fourth BJT transistor Q4 and a first end of the twenty-sixth capacitor C26 are coupled to the ground GND. A collector of the fourth BJT transistor Q4 is coupled to a first end of the forty-first resistor R41. A second end of the third Zener diode Z3 is electrically connected to first ends of the fifth diode D5 and the thirty-ninth resistor R39 and to a second end of the twenty-sixth capacitor C26. Wherein, the thirty-ninth resistor R39 and the fifth diode D5 are coupled to each other at their respective second end, and then further electrically connect to a junction of the second ends of the fourth diode D4 and the thirty-seventh resistor R37 and the first end of the thirty-eighth resistor R38, so that the control signal is input via the junction of the second ends of the fourth diode D4 and the fifth diode D5.

The fifth BJT transistor Q5 has a base electrically connected to a first end of the forth-second resistor R42 and a second end of the forty-first resistor R41, an emitter coupled to a second end of the forty-second resistor R42 and the emitter of the second BJT transistor Q2, and a collector electrically connected to a first end of the fortieth resistor R40. The fortieth resistor R40 has a second electrically connected to the third pin of the MOSFET transistor U′ in the second output driver 312.

When it is desired to add the external car amplifier to a car, just directly connect the external car amplifier to the car battery 6, which is 12V, for example, without the need of using any additional circuit for voltage conversion, and only a single power supply circuit is needed. Unlike the prior art external car amplifier, which requires a boost circuit to boost and convert the in-car power supply of 12V into the required high voltage while a large amount of energy loss will occur during the conversion by the boost circuit and must use a dual power supply circuit to result in complicated wiring, the present invention directly uses the car battery 6 as the power supply thereof to enable not only simple and quick wiring, but also effectively reduced overall production cost as well as power consumption.

When using the external car amplifier of the present invention to drive the speaker 7, the audio source connector J in the source amplifying unit 10 receives the input audio signal and sends the same to source amplifying unit 10 for signal amplification. The amplified input audio signal is then transmitted to the phase inverting unit 12 and the second PWM unit 24 of the PWM module 2. The phase inverting unit 12 inverts the signal phase of the amplified input audio signal to generate the phase-inverted audio signal to the first PWM unit 23 of the PWM module 2. Meanwhile, the square wave generating unit 20 generates the square wave signal, and the triangular wave generating unit 22 receives and converts the square wave signal into the triangular wave signal. The triangular wave signal is transmitted to the first and the second PWM unit 23, 24, so that the first PWM unit 23 conducts comparisons on the received phase-inverted signal and the triangular wave signal to generate the first PWM signal, and the second PWM unit 24 conducts comparisons on the amplified input audio signal and the triangular wave signal to generate the second PWM signal.

Then, the first and the second output driver 311, 312 of the output-stage unit 31 of the drive amplifier module 3 receive the first and the second PWM signal, respectively, and control their on/off based on the received first and second PWM signals. And, the first and the second PWM signals are output at the fifth and eighth pins of the MOSFET transistors U and U′, respectively, to the first and the second amplifying device 331, 332 of the power amplifying unit 33, respectively. The first and second amplifying devices 331, 332 respectively amplify the power of the received first and second PWM signals to generate the first and second high-current PWM signals, respectively. In the process of power amplification, the first and second high-current PWM signals are filtered by the low-pass filter circuits in the first and second amplifying devices 331, 332, respectively, to remove undesired high-frequency signals, so as to generate the high-current audio signals for driving the speaker 7. Therefore, the present invention can, on the one hand, have reduced production cost and power consumption, and on the other hand, output high-current and high-power audio signals at higher amplifier efficiency.

In conclusion, the present invention provides an external car amplifier capable of producing high power, which has at least the following advantages: (1) capable of outputting high-current and high-power audio signals; (2) enabling reduced production cost thereof; (3) enabling low power consumption; (4) having high power amplification efficiency; and (5) not requiring additional boost circuit and dual power supply when being connected to a car for use. That is, the present invention can directly use the car battery as the power supply thereof to thereby avoid loss in energy conversion as well as complicated installation and wiring.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An external car amplifier capable of producing high power, comprising:
an audio amplifier module including a source amplifying unit for receiving an input audio signal, and a phase inverting unit for inverting signal phase of the received audio signal; and the source amplifying unit being coupled to the phase inverting unit;
a pulse width modulation (PWM) module being electrically connected to the audio amplifier module for receiving and comparing signals transmitted from the phase inverting unit and the source amplifying unit with a signal in the PWM module, so as to generate a PWM signal;
a drive amplifier module being coupled to the PWM module, and including an output-stage unit and a power amplifying unit; the PWM signal controlling the output-stage unit and being amplified by the power amplifying unit to generate a high-current audio signal;
an on/off control and mute module for receiving a control signal to control the drive amplifier module; and
a filter and power supply module including a power filtering unit and power supplying unit; the power filtering unit being coupled to the power amplifying unit, the on/off control and mute module, and the power supplying unit; and the power supplying unit being coupled to the audio amplifier module, the PWM module, and the drive amplifier module.

2. The external car amplifier capable of producing high power as claimed in claim 1, wherein the on/off control and mute module has a first terminal, a second terminal, and a third terminal; the first terminal being coupled to the power amplifying unit, the second terminal being coupled to the power filtering unit, and the third terminal being used to receive the control signal.

3. The external car amplifier capable of producing high power as claimed in claim 1, wherein the power filtering unit is coupled to a car battery for filtering power supply from the car battery and supplying the filtered power supply to the power supplying unit, the on/off control and mute module, and the power amplifying unit.

4. The external car amplifier capable of producing high power as claimed in claim 1, wherein the PWM module includes:
a square wave generating unit being electrically connected to the power supplying unit for generating a square wave signal;
a triangular wave generating unit being coupled to the square wave generating unit and used to receive and convert the square wave signal into a triangular wave signal;
a first PWM unit being coupled to the triangular wave generating unit and the phase inverting unit, and conducting comparisons on the triangular wave signal generated by the triangular wave generating unit and a phase-inverted signal generated by the phase inverting unit to generate a first PWM signal; and
a second PWM unit being coupled to the source amplifying unit and the triangular wave generating unit, and conducting comparisons on an amplified input audio signal generated by the source amplifying unit and the triangular wave signal generated by the triangular wave generating unit to generate a second PWM signal.

5. The external car amplifier capable of producing high power as claimed in claim 4, wherein the output-stage unit includes a first output driver and a second output driver, which are electrically connected to the first and the second PWM unit, respectively, and to the power supplying unit; and the first and the second output driver receiving the first and the second PWM signal, respectively, and being controlled by the first and the second PWM signal to on/off.

6. The external car amplifier capable of producing high power as claimed in claim 5, wherein the power amplifying unit includes a first amplifying device and a second amplifying device, which are coupled to the first and the second output driver, respectively, and to the power supplying unit, the on/off control and mute module, and the power filtering unit.

7. The external car-amplifier capable of producing high power as claimed in claim 1, wherein the power amplifying unit is electrically connected to a speaker and uses the generated high-current audio signal to drive the speaker.

8. The external car amplifier capable of producing high power as claimed in claim 2, wherein the power amplifying unit is electrically connected to a speaker and uses the generated high-current audio signal to drive the speaker.

9. The external car amplifier capable of producing high power as claimed in claim 3, wherein the power amplifying unit is electrically connected to a speaker and uses the generated high-current audio signal to drive the speaker.

10. The external car amplifier capable of producing high power as claimed in claim 4, wherein the power amplifying unit is electrically connected to a speaker and uses the generated high-current audio signal to drive the speaker.

11. The external car amplifier capable of producing high power as claimed in claim 5, wherein the power amplifying unit is electrically connected to a speaker and uses the generated high-current audio signal to drive the speaker.

12. The external car amplifier capable of producing high power as claimed in claim 6, wherein the power amplifying unit is: electrically connected to a speaker and uses the generated high-current audio signal to drive the speaker.
